(19) United States
(12) Patent Application Publication
(10) Pub. No.: US 2011/0200772 A1
(43) Pub. Date: Aug. 18, 2011

(54) HIGH STRENGTH POLYMER COMPOSITIONS CONTAINING HYBRID ORGANIC/INORGANIC PIGMENTS

(76) Inventors: Lori A. Niewold, Anthony, NM (US); Alejandra Ramirez Caro, Berlin (DE)

(21) Appl. No.: 13/057,921

(22) PCT Filed: Aug. 6, 2009
(86) PCT No.: PCT/US09/53025

§ 371 Date: May 2, 2011

Related U.S. Application Data
(60) Provisional application No. 61/086,668, filed on Aug. 6, 2008.
(60) Provisional application No. 61/202,906, filed on Apr. 17, 2009.

(51) Int. Cl. C08K 3/34; C08K 5/3417; C08K 5/08; C08K 5/3437; C08K 5/23; B65D 23/00; B29C 49/04; B29C 49/06

(52) U.S. Cl. 428/35.7; 524/445; 524/94; 524/358; 524/87; 524/88; 524/190; 215/382; 264/541; 264/540

(57) ABSTRACT

A plastic extrusion or molding composition includes a polymer and a fibrous clay and/or a hybrid organic/inorganic pigment. The hybrid organic/inorganic pigment comprises a fibrous clay and an organic dye or organic pigment, and combinations thereof. Plastic extrusions and moldings are formed from the composition. In addition, a method of making a plastic component from the polymer and fibrous clay or hybrid organic/inorganic pigment is provided.

### RELATED APPLICATIONS

This application claims the benefit of priority of U.S. Provisional Application Ser. Nos. 61/086,668 filed Aug. 6, 2008 and 61/202,906 filed Apr. 17, 2009. This application discloses subject matter similar to that disclosed in U.S. Pat. Nos. 7,052,541; 7,425,235; and 7,429,294; PCT/US2008/084786, filed Nov. 26, 2008; PCT/US2009/031572, filed Jan. 21, 2009; PCT/US2009/036680 filed Mar. 10, 2009; and PCT/US2009/036684 filed Mar. 10, 2009, the contents of each herein incorporated by reference in their entirety.

The government may own rights in the present invention pursuant to National Science Foundation Contract No. 0724210.

### FIELD OF TILE DISCLOSURE

This disclosure relates to high strength polymer compositions for forming plastic components including sheets, films, and containers.

### BACKGROUND

High density polyethylene (HDPE) is widely used in the container industry because of its superior mechanical properties and recyclability.¹ HDPE, however, is made from fossil fuels, and availability of HDPE may become of great concern in view of the finite amount of fossil fuels and recent oil price spikes. Therefore, low cost containers with high strength mechanical properties are a challenge. One way to reduce costs and conserve energy resources is to reduce container wall thickness. Thinner container wall thickness, however, results in decreased container wall strength, and loss of container integrity.

Plastics films, sheets, and containers can be transparent, translucent, or opaque. Opacity can be valuable where the film or container houses ultraviolet radiation (UV) sensitive products. TiO₂ is often used to provide opacity to plastics because of its refractive index. It is a bright pigment due to its low impurity levels and can also provide UV protection depending on the particle size and crystalline phase.

Opacity is related to the refractive index of a material. In the case of water or glass, for example, as light passes through the object, it encounters the refractive index of that material and is scattered or bent, resulting in the diminished opacity. TiO₂ causes the light to be scattered backwards, thus if TiO₂ is incorporated into an object, the object appears opaque.

Packaging materials composed of plastics, such as polyolefin resins, encompass a large portion of the market segment. These segments include applications such as rigid and flexible packaging, of varied thickness. As thinner films are demanded in order to lower the cost of packaging materials throughout the supply chain, demands from the performance of the pigments such as TiO₂, within the plastics are increased, from physical, mechanical, and chemical perspectives. Examples of these demands from thinner films which use TiO₂ as a pigment to improve opacity of the resin include maintaining consistent appearance of the opaque plastic, eliminating defects, and improving yield of the pigmented plastic. These demands can be met through adequate dispersion of the TiO₂. However, adequate dispersion of fine TiO₂ can often be a difficult task.

Colored minerals, earths and ochers, have been used throughout human history. Natural earth minerals lend themselves to a wide range of decorations, from body paint to painting on natural or constructed walls. The colors are extremely stable, as can be seen in ancient paintings that have lasted to this day. The use of colored earth pigments is found even in the oldest civilizations.

In the scientific literature, the term Maya blue refers to a “turquoise” brilliant shade of blue that is found on murals and archaeological artifacts, for example, throughout Mesoamerica. It is described in the literature as being composed of palygorskite clay and indigo, that when mixed and heated, produce the stable brilliant blue color similar to that found in Mesoamerica.

U.S. Pat. Nos. 7,052,541 and 7,429,294 describe color compositions comprising neutral indigo derivative pigments and dyes complexed to the surface of inorganic clays. These materials are useful as paints and coatings for artistic and industrial purposes, including use in cements, plastics, papers and polymers. Upon grinding and heating the organic and inorganic component as solid mixtures or in aqueous solutions, the resulting color compositions have unprecedented stability relative to the original starting materials.

### SUMMARY

There exists a need to reduce the amount of polymer used in containers and packaging. There exists a need for thinner but stronger-walled polymer containers. There is a need for improved opacity, higher strength films, sheets, and containers.

These and other needs are met by embodiments of the present disclosure which provide a polymer extrusion or molding composition comprising a polymer and a fibrous clay or a hybrid organic/inorganic pigment. The hybrid organic/inorganic pigment comprises a fibrous clay and an organic dye or organic pigment.

According to another embodiment of the present disclosure, a plastic component is provided. The plastic component is formed from a polymer extrusion or molding composition comprising a polymer and a fibrous clay or a hybrid organic/inorganic pigment. The hybrid organic/inorganic pigment comprises a fibrous clay and an organic dye or organic pigment.

According to another embodiment of the present disclosure, an extruded plastic film is provided comprising a polymer and a fibrous clay or a hybrid organic/inorganic pigment. The hybrid organic/inorganic pigment comprises a fibrous clay and an organic dye or organic pigment.

According to another embodiment of the present disclosure, a molded plastic container is provided comprising a polymer and a fibrous clay or a hybrid organic/inorganic pigment. The hybrid organic/inorganic pigment comprises a fibrous clay and an organic dye or organic pigment.

According to another embodiment of the present disclosure, a method of making a plastic component is provided comprising forming a polymer composition by mixing a polymer and a fibrous clay or a hybrid organic/inorganic pigment. The hybrid organic/inorganic pigment comprises a fibrous clay and an organic dye or organic pigment. The polymer composition is melted and the melted polymer composition is molded or extruded.

### BRIEF DESCRIPTION OF THE DRAWINGS

FIG. 1 is an illustration of a bottle according to an embodiment of the present disclosure.

FIG. 2 is an illustration of a bottle according to an embodiment of the present disclosure.

FIG. 3 is an illustration of a bottle according to an embodiment of the present disclosure.

FIG. 4 illustrates the effect of adding a fibrous clay or a hybrid organic/inorganic pigment to a polymer according to the present disclosure.

FIG. 5 is a differential scanning calorimetry (DSC) spectrum of HDPE neat.

FIG. 6 is a DSC spectrum of a polymer extrusion or molding composition according to the present disclosure.

FIG. 7 is a DSC spectrum of a polymer extrusion or molding composition according to the present disclosure.

FIG. 8 is a DSC spectrum of a polymer extrusion or molding composition according to the present disclosure.

FIG. 9 is a DSC spectrum of a polymer and pigment composition.

FIG. 10 is a DSC spectrum of a polymer extrusion or molding composition according to the present disclosure.

FIG. 11 is a DSC spectrum of a polymer extrusion or molding composition according to the present disclosure.

FIG. 12 illustrates DSC spectra of exothermic peaks during cooling of a number of samples.

FIG. 13 illustrates the variables of a DSC exotherm.

### DETAILED DISCLOSURE

According to an embodiment of the present disclosure, a plastic extrusion or molding composition is provided comprising a polymer and a fibrous clay or a hybrid organic/inorganic pigment. The hybrid organic/inorganic pigment comprises a fibrous clay and an organic dye or organic pigment. In certain embodiments, the fibrous clay is palygorskite, sepiolite, or mixtures thereof. In certain embodiments, the hybrid organic/inorganic pigment is a reaction product of the organic dye or organic pigment and the fibrous clay.

In certain embodiments of the disclosure, the polymer composition comprises the hybrid organic dye or organic pigment and the hybrid organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof. In certain embodiments, the hybrid organic/inorganic pigment further comprises a rutile pigment, a spinel pigment, a bismuth vanadate pigment, a cerium sulfide pigment, and combinations thereof.

In certain embodiments of the present disclosure, the polymer is selected from the group consisting of polyolefins, including ultrahigh molecular weight polyethylene (UHMWPE), high molecular weight polyethylene (HMWPE), high density polyethylene (HDPE), medium density polyethylene (MDPE), low density polyethylene (LDPE), linear low density polyethylene (LLDPE), very low density polyethylene (VLDPE), ultra low molecular weight polyethylene (ULMWPE), isotactic polypropylene, syndiotactic polypropylene, atactic polypropylene, polyisobutylene, and ethylene-propylene copolymer; polyesters, including polyethylene terephthalate and polybutylene terephthalate; polyacrylates, including polymethyl methacrylate; polycarbonates; hydrocarbon resins; polyamides, including polyhexamethylene adipamide; cellulosics, including cellophane; polyketones; polyethers; polysulfones; polyvinyl alcohols; polyvinyl acetates; polyvinyl butyrals; polyvinyl chlorides; fluoropolymers, including polyvinylidene fluoride and ethylene-tetrafluoroethylene copolymer; polyvinylidene chlorides; polyacrylonitriles, polybutadienes, polystyrenes; ionomers; silicones; epoxies; phenolics; and copolymers, including poly(ethylene-vinylacetate) and acrylonitrile-butadiene-styrene copolymer; and combinations thereof. In certain embodiments of the present disclosure, the polymer is a thermoplastic.

In certain embodiments of the disclosure, the hybrid organic/inorganic pigment comprises from about 1 wt. % to about 90 wt. % clay based on the total weight of the clay and organic dye or organic pigment. In certain embodiments, the hybrid organic/inorganic pigment comprises from about 5 wt. % to about 85 wt. % clay based on the total weight of the clay and organic dye or organic pigment. In certain embodiments, the hybrid organic/inorganic pigment comprises from about 20 wt. % to about 80 wt. % clay based on the total weight of the clay and organic dye or organic pigment. In certain embodiments, the hybrid organic/inorganic pigment comprises from about 50 wt. % to about 70 wt. % clay based on the total weight of the clay and organic dye or organic pigment.

In certain embodiments of the present disclosure, the polymer extrusion or molding composition comprises from about 0.1 wt. % to about 10 wt. % of fibrous clay and/or hybrid organic/inorganic pigment based on the total weight of the polymer composition. In certain embodiments, the polymer extrusion or molding composition comprises from about 2 wt. % to about 7 wt. % of fibrous clay or hybrid organic/inorganic pigment based on the total weight of the polymer composition. In certain embodiments, the polymer extrusion or molding composition comprises about 4 wt. % of fibrous clay or hybrid organic/inorganic pigment based on the total weight of the polymer composition.

In certain embodiments of the present disclosure, the polymer extrusion or molding composition is a solid at room temperature.

In certain embodiments of the present disclosure, a plastic component is formed from the polymer extrusion or molding composition according to the present disclosure. The plastic component can be an extruded component, such as a film or sheet. Such extruded components can be formed from polymer compositions including a polymer selected from the group consisting of polyolefins, polyesters, polyamides, cellulosics, polyvinyl acetates, fluoropolymers, polyvinylidene chlorides, and copolymers and combinations thereof. In certain embodiments, the extruded plastic film comprises a polyolefin selected from the group consisting of high density polyethylene (HDPE), medium density polyethylene (MDPE), low density polyethylene (LDPE), linear low density polyethylene (LLDPE), polypropylene, and copolymers and combinations thereof.

In certain embodiments, the extruded film comprises the hybrid organic dye or organic pigment and the organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof. In certain embodiments, the hybrid organic/inorganic pigment further comprises a rutile pigment, a spinel pigment, a bismuth vanadate pigment, a cerium sulfide pigment, and combinations thereof.

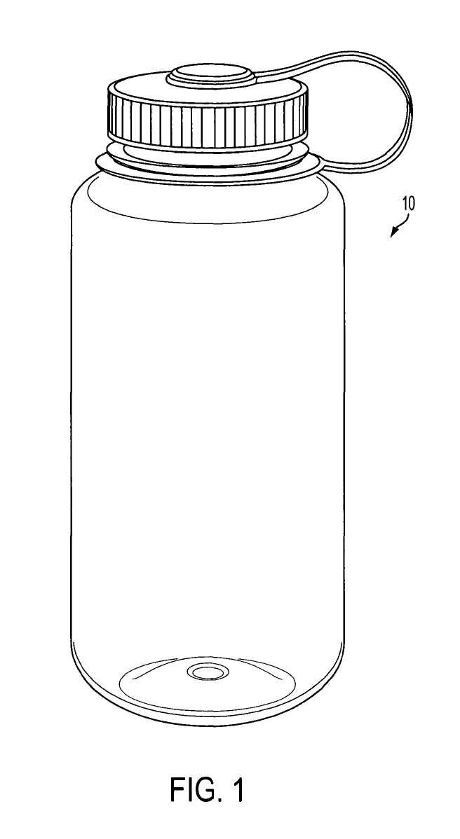

In certain embodiments, the plastic component is an injection molded component. Injected molded components can include a bottle 10 formed from a polycarbonate composition, as shown in FIG. 1.

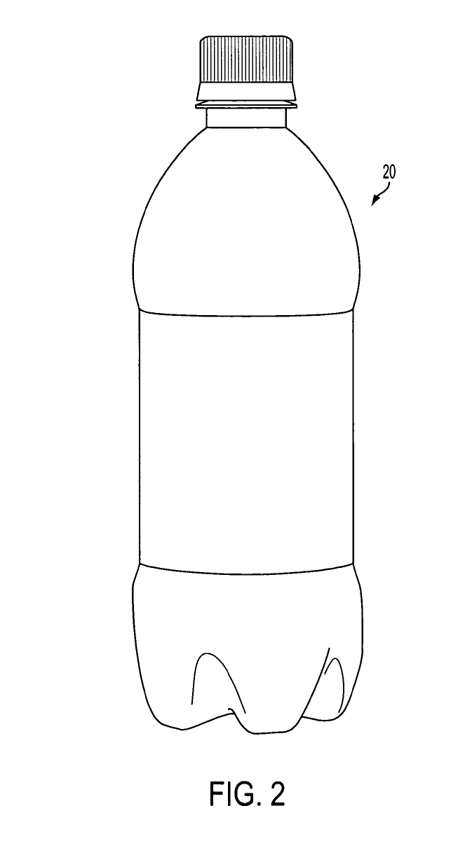

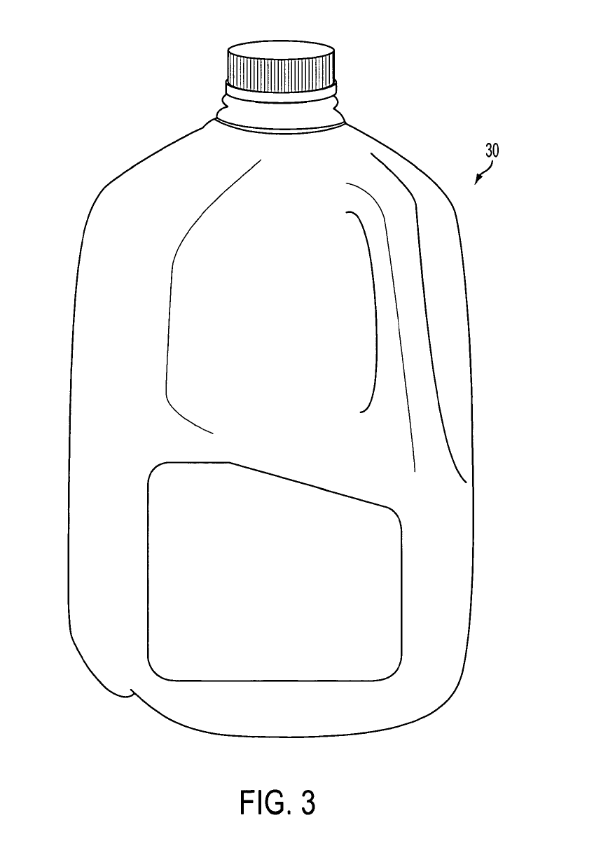

In certain embodiments, the plastic component is a blow molded component, such as a bottle. Blow molded bottles according the present disclosure include a soft drink bottle 20 made from a polyethylene terephthalate composition, as shown in FIG. 2, and a milk jug 30 made from HDPE, as shown in FIG. 3

In certain embodiments, the polymer composition can further comprise an opacifying pigment, such as TiO₂. Thin extruded films according to the present disclosure, which contain TiO₂, offer improved strength and opacity over extruded films without the fibrous clay or hybrid organic/inorganic pigment and TiO₂. In certain embodiments, the extruded plastic film can comprise from about 0.1 wt. % to about 10 wt. % TiO₂ based on the total weight of the plastic film. In certain embodiments, the hybrid organic/inorganic pigment in the plastic film comprises from about 1 wt. % to about 90 wt. % fibrous clay based on the total weight of the clay and organic dye or organic pigment. In certain embodiments, the plastic film comprises from about 0.1 wt. % to about 10 wt. % of fibrous clay or hybrid organic/inorganic pigment based on the total weight of the plastic film.

In certain embodiments of the present disclosure, a molded plastic container is provided comprising a polymer and a fibrous clay or a hybrid organic/inorganic pigment. The hybrid organic/inorganic pigment comprises a fibrous clay and an organic dye or organic pigment. In certain embodiments, the fibrous clay is palygorskite, sepiolite, or mixtures thereof. In certain embodiments, the hybrid organic/inorganic pigment is a reaction product of the organic dye or organic pigment and the clay.

In certain embodiments, the molded plastic container comprises the hybrid organic/inorganic pigment and the organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes; and combinations thereof. In certain embodiments, the hybrid organic/inorganic pigment further comprises a rutile pigment, a spinel pigment, a bismuth vanadate pigment, a cerium sulfide pigment, and combinations thereof.

In certain embodiments of the present disclosure, the polymer in the molded container is selected from the group consisting of polyolefins, polyesters, polycarbonates, polyamides, polyvinyl chlorides and copolymers and combinations thereof. In certain embodiments, the polymer is selected from the group consisting of high density polyethylene (HDPE), medium density polyethylene (MDPE), low density polyethylene (LDPE), linear low density polyethylene (LLDPE), polypropylene, polyethylene terephthalate, polybutylene terephthalate, polyhexamethylene adipamide, polycarbonate, and acrylonitrile-butadiene-styrene copolymer.

In certain embodiments, the molded container is a blow molded or injection molded bottle.

In certain embodiments, the hybrid organic/inorganic pigment in the molded container comprises from about 1 wt. % to about 90 wt. % clay based on the total weight of the clay and organic dye or organic pigment. In certain embodiments, the molded container comprises from about 0.1 wt. % to about 10 wt. % fibrous clay and/or hybrid organic/inorganic pigment based on the total weight of the molded container.

In certain embodiments, the molded container has improved mechanical and physical properties, and greater resistance to failure from dropping six feet onto a hard surface than molded containers comprising the same polymer but not including the fibrous clay or hybrid organic/inorganic pigment. The drop test performed on the bottles was a modified version of ASTM D2463-95. In certain embodiments, the container has about ten times or greater resistance to failure from dropping six feet onto a hard surface than the molded containers not including the fibrous clay or hybrid organic/inorganic pigment. In certain embodiments, the container has a wall thickness of about 80% the wall thickness of molded containers not including the fibrous clay or hybrid organic/inorganic pigment, while still maintaining improved wall strength. In certain embodiments the wall thickness of plastic bottles according to the present disclosure range from about 24 mils to about 30 mils. In certain embodiments, bottles according to the present disclosure can withstand a 6 foot drop test onto a hard surface over 50 times without failure of the bottle wall.

In certain embodiments of the present disclosure, a method of making a plastic component is provided comprising forming a polymer composition by mixing a polymer and a fibrous clay and/or a hybrid organic/inorganic pigment. The hybrid organic/inorganic pigment comprises a fibrous clay and an organic dye or organic pigment, and combinations thereof. The polymer composition is melted. The melted polymer composition is molded or extruded to form the plastic component. In certain embodiments, the fibrous clay is palygorskite, sepiolite, or mixtures thereof. In certain embodiments, the hybrid organic/inorganic pigment is a reaction product of the organic dye or organic pigment and the clay, and combinations thereof.

In certain embodiments, the polymer composition used in the method of making a plastic component comprises the hybrid organic/inorganic pigment and the organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof. In certain embodiments, the hybrid organic/inorganic pigment further comprises a rutile pigment, a spinel pigment, a bismuth vanadate pigment, a cerium sulfide pigment, and combinations thereof.

In certain embodiments, the polymer used in the method of making a plastic component is selected from the group consisting of polyolefins, polyesters, polyacrylates, polycarbonates, hydrocarbon resins, polyamides, cellulosics, polyketones, polyethers, polysulfones, polyvinyl alcohols, polyvinyl acetates, polyvinyl butyrals, polyvinyl chlorides, fluoropolymers, polyvinylidene chlorides, polyacrylonitrile, polybutadienes, polystyrenes, ionomers, silicones, epoxies, and phenolics, and copolymers and combinations thereof. In certain embodiments, the polymer is a thermoplastic.

In certain embodiments of the present disclosure, the melted polymer composition is extruded by blown film extrusion. In certain embodiments, the melted polymer composition is molded by blow molding. The blow molding can include extrusion blow molding, injection blow molding, or stretch blow molding.

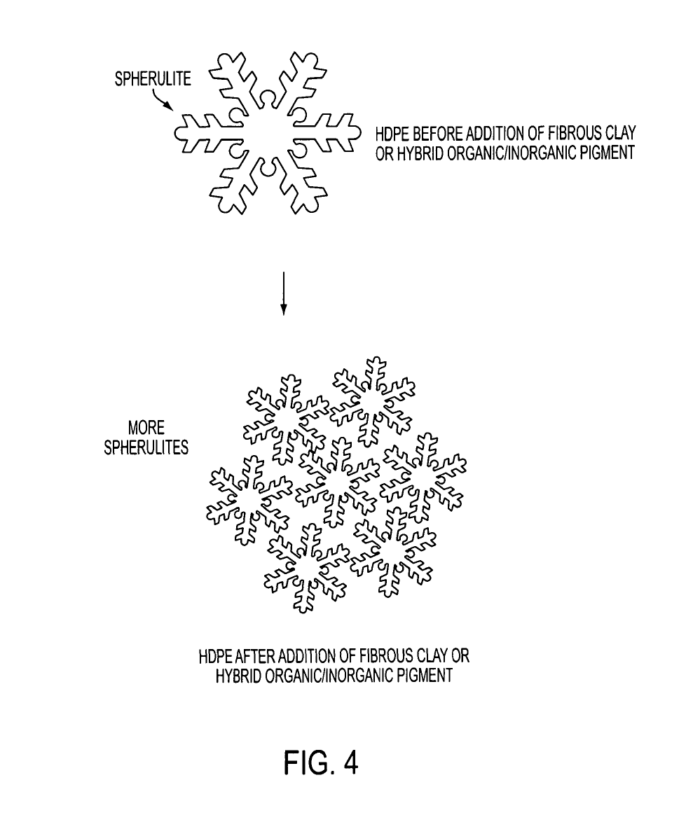

Polymer compositions according to the present disclosure provide higher strength films and articles. Without wishing to be bound to any particular theory, it is believed that the higher strength results from the fibrous clay or hybrid pigment causing the production of a greater number of smaller polymer spherulites, which results in lower polymer crystallinity, and thus higher strength. As shown in FIG. 4, the addition of fibrous clay or hybrid organic/inorganic pigment results in a greater number of smaller polymer spherulites. It is believed that the fibrous clay or hybrid organic/inorganic pigment increases the crystallization rate, which in addition to providing smaller polymer spherulites, also provides faster cooling from the melt; and therefore, faster throughput. Crystallization at higher temperatures is also provided. Thus, less energy is required for crystallization and faster throughput is achieved. In addition, the composition according to the present disclosure increases the number of nucleation seeds. The present disclosure provides lower % crystallinity, which results in a stronger polymer, whereas higher % crystallinity results in a more brittle polymer.

It is further believed that because the refractive index of a material depends on the particle size and the particle shape, by bringing together a fibrous clay having an average particle size about 0.1 to about 100 μm with a fine, spherical TiO₂ pigment, a unique combination of their refractive indices would result in optimum scattering and provide an improved opaque film or plastic packaging material.

In certain embodiments, the TiO₂ pigments are spherical, and when used alone in applications where a thinner film is needed, may lead to mechanical instability of the thin film or package. However, fibrous clays, having a needle-like morphology, including palygorskite and sepiolite, when mixed or ground together with the spherical TiO₂ pigments, result in a hybrid mixture that exploit the mechanical and physical properties of the needle-like morphology clay along with the high opacity of the TiO₂ while not compromising the final product's integrity.

Hybrid organic/inorganic pigments comprising numerous classes of dyes or pigments that are reacted onto a clay surface such as palygorskite or sepiolite exhibit excellent physical, chemical, and mechanical properties. These hybrid pigments are fibrous and do not alter the crystallization of plastics such as polyolefins, making them particularly suited to thinner film packaging applications, for example.

In certain embodiments of the present disclosure, the hybrid organic/inorganic pigment is prepared by mixing about 1 wt. % to about 90 wt. % of the organic dye or organic pigment based on the total weight of the dye or pigment and clay and heating the mixture.

In certain embodiments, the organic dye or organic pigment is present in an amount greater than 20 wt. % based on the total weight of the dye or pigment and clay. In certain embodiments, the dye or pigment and fibrous clay are heated to a temperature of about 90° C. to about 350° C. for about 10 minutes to about 24 hours to react the organic dye or organic pigment with the clay. The dye or pigment and fibrous clay can be ground prior to mixing, after mixing, and/or after heating to provide hybrid organic/inorganic pigment of a desired particle size.

Analysis by Differential Scanning Calorimetry (DSC)

The physical properties of HDPE neat and HDPE compositions were determined by DSC.

### EXPERIMENTAL

HDPE raw material and HDPE compositions were homogenized and blow molded into a 250 mL bottle shape. A 17.6 mg sample was placed inside an aluminum crucible with lid and measured using a Seiko Instrument DSC 6200-EXSTAR 6000 differential scanning calorimeter with a temperature program shown in Table 1.

TABLE 1
DSC temperature program.

| | Heating | Cooling |
|---|---|---|
| Tᵢₙᵢₜᵢₐₗ (° C.) | 40 | 300 |
| T_{final} (° C.) | 300 | 40 |
| Rate (° C./min) | 125 | 10 |
| Isotherm (min) | 10 | 0 |

Results

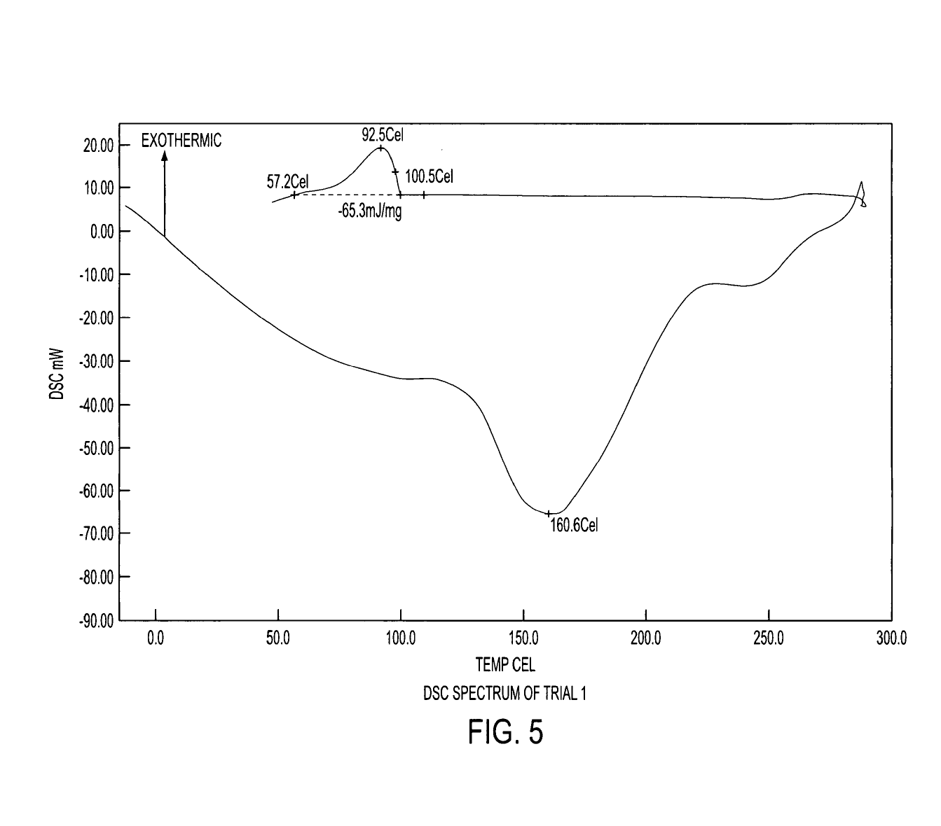

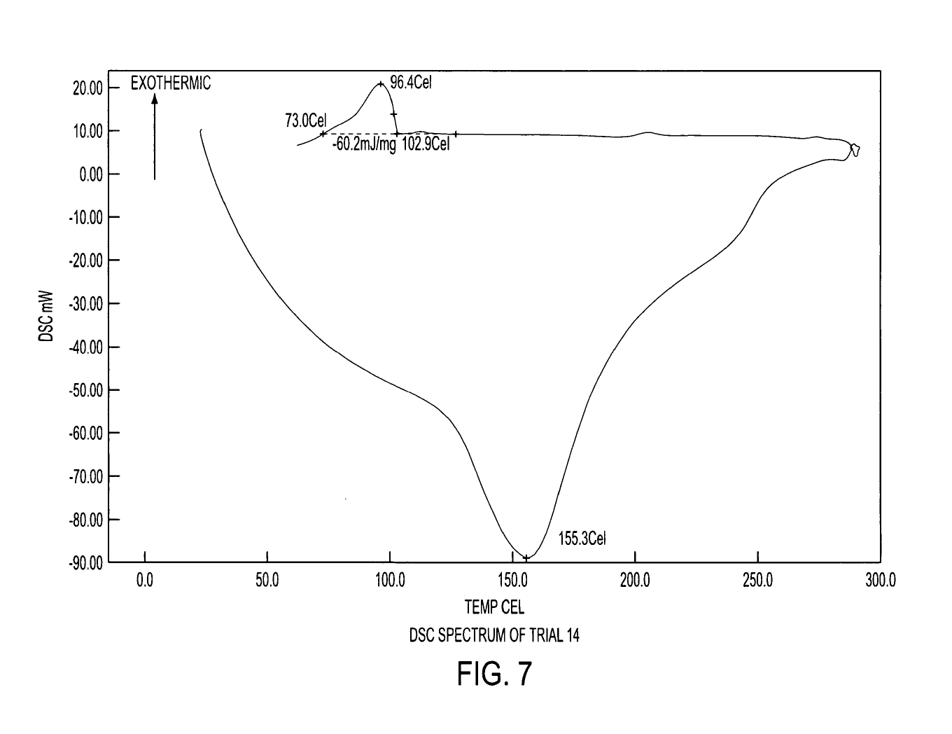

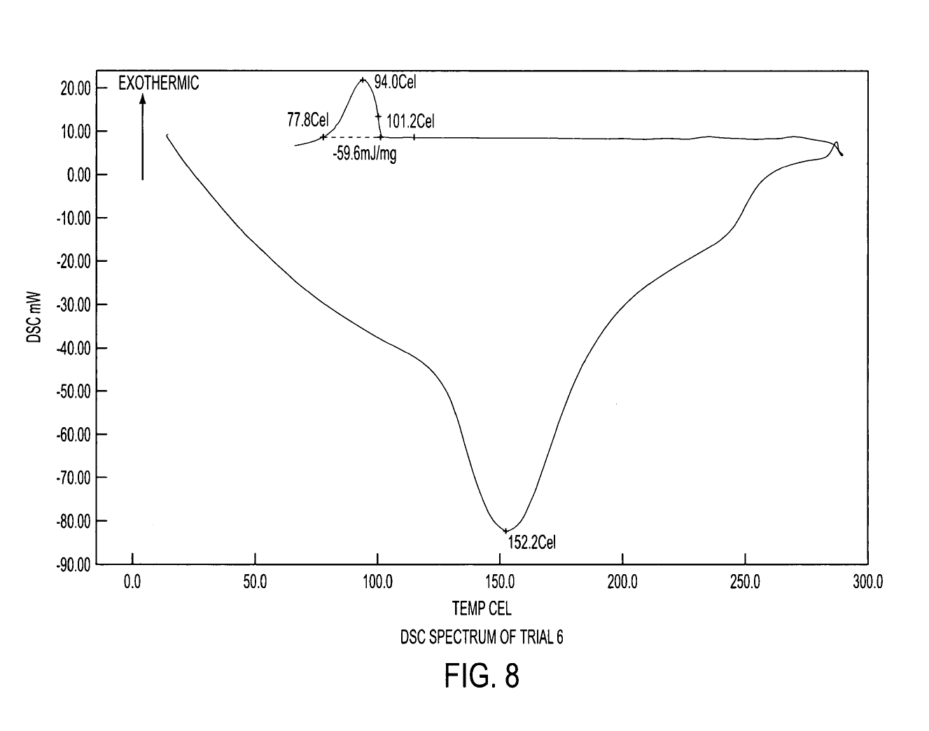

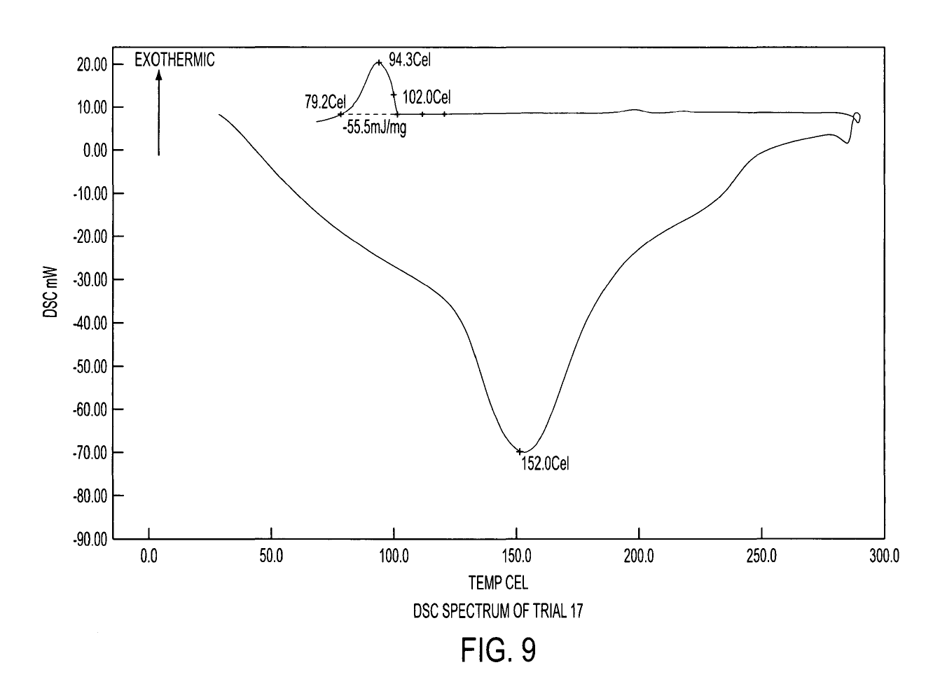

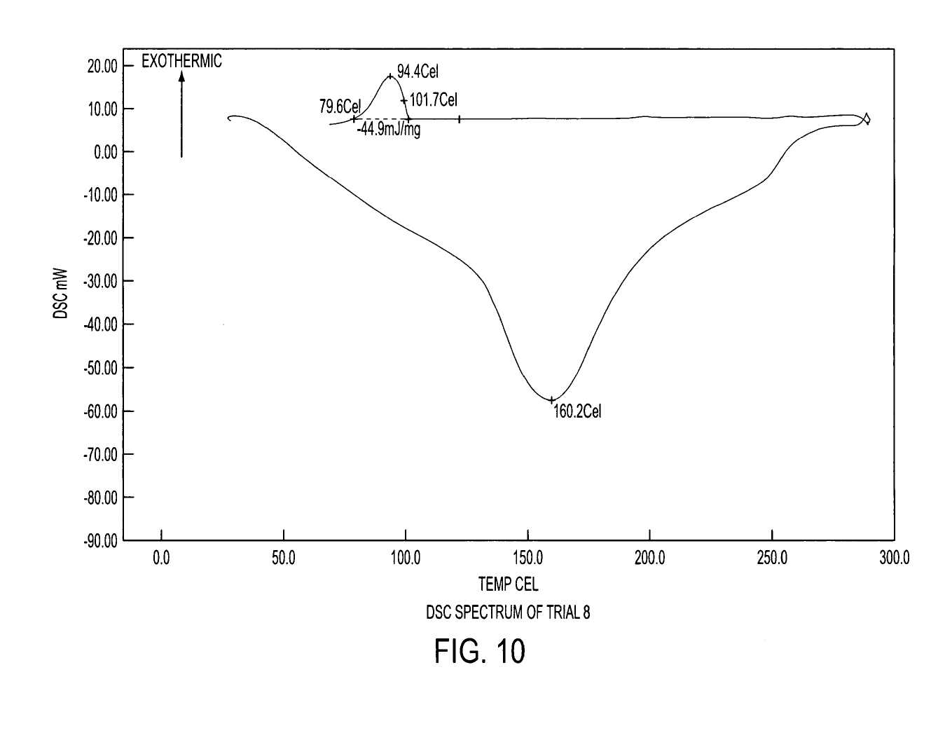

The complete DSC spectrums of the HDPE neat and HDPE composition are shown in FIGS. 5-11. Table 2 is a matrix of the various samples prepared and analyzed. All samples displayed an endothermic peak from heating assigned to the melting process and an exothermic peak during cooling corresponding to the crystallization process. DSC measurements during melting showed four bands related to the different spherulite crystal structure present in HDPE neat. These bands were broader once the hybrid pigment or dye was added to the melt, which could be an indication of crystal structural changes.² In addition, a decrease in melting temperature was observed in all composites. On the other hand, Table 3 summarizes the crystallization exotherms analyzed according to the procedure outlined by E. Harkin-Jones et al.³ where variables such as Tₚₑₐₖ, Tₒₙₛₑₜ, Sᵢ, Δ_{w}, ΔH ₒ and % crystallinity provided the following information:
1. Peak temperature (Tₚₑₐₖ) shifted to higher temperatures in all samples when compared to HDPE neat. This temperature change is an indication of crystallization at higher temperatures.
2. Spherulite size distribution (Δw) was notably decreased in all samples when compared to HDPE neat. This effect is due to the increased amount of nucleation seeds by the hybrid pigment or dye existence, which allowed more and smaller spherulites to grow.
3. Degree of crystallinity (% Crystallinity) was observed to decrease in all samples when compared to HDPE neat. This could be because of crystallization imperfection due to the faster rate, as explained by P. Zou et al.¹ who also observed this behavior in HDPE composites.
4. Rate of crystallization (Sᵢ) measured from the exothermic peak exhibited a higher crystallinity rate once the hybrid pigment or dye was added to HDPE neat. This implies the addition of any of these materials could act as nucleating agents for the HPDE matrix.

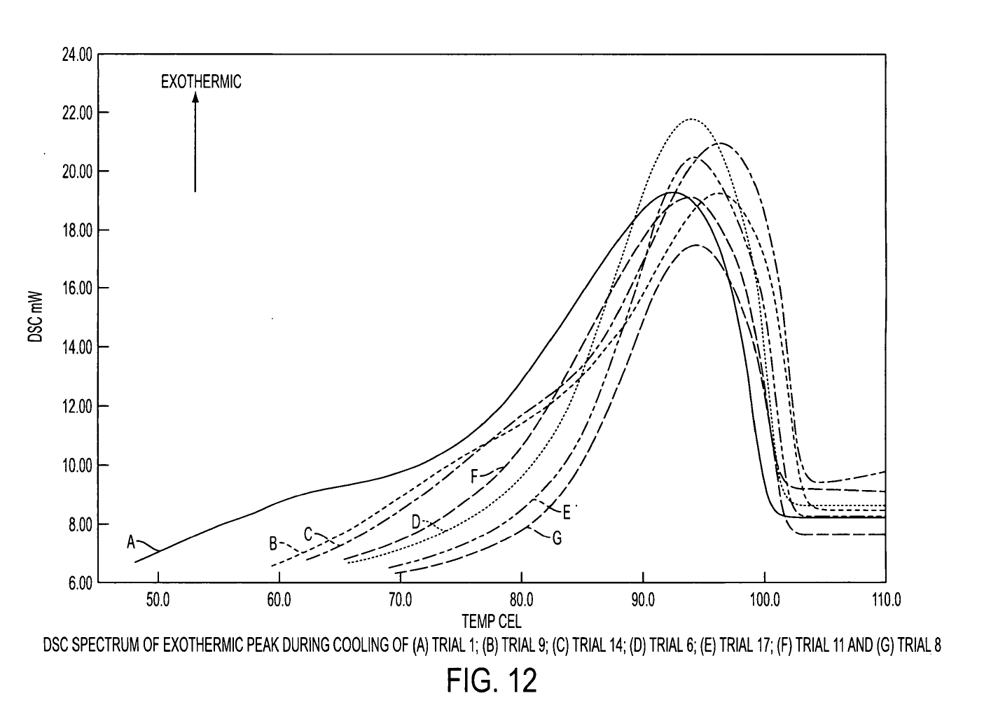

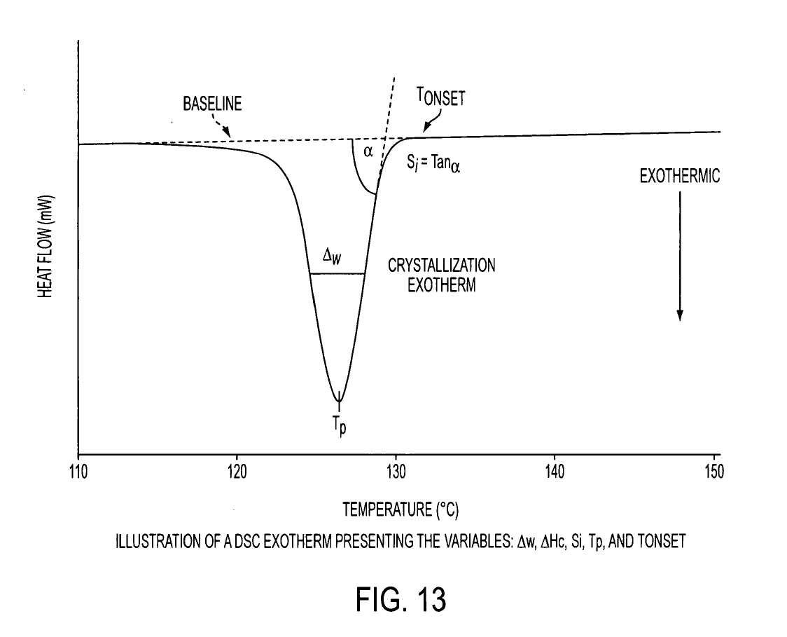

The exothermic peaks during cooling of a number of the trials are shown in FIG. 12. FIG. 13 illustrates the variables Δw, ΔHc, Si, Tp, and Tonset, with regard to an exothermic peak.

TABLE 2
Trial Matrix

| | Thickness (mil) | | | | Clay in |
|---|---|---|---|---|---|
| | 30 | 27 | 24 | Pigment | Pigment, % |
| Trials 1-3 | Natural | N/A | N/A | None | 0 |
| | HDPE | | | | |
| Trials 4-6 | 4% Pigment | 4% Pigment | 4% Pigment | 100% Milled | 100 |
| | in HDPE | in HDPE | in HDPE | Clay | |
| Trials 7-9 | 4% Pigment | 4% Pigment | 4% Pigment | Orange | 80 |
| | in HDPE | in HDPE | in HDPE | OR2800 | |
| Trials 9-11 | 4% Pigment | 4% Pigment | 4% Pigment | Yellow Y2300F | 70 |
| | in HDPE | in HDPE | in HDPE | | |
| Trials 12-14 | 4% Pigment | 4% Pigment | 4% Pigment | Mayatx NBPA- | 50 |
| | in HDPE | in HDPE | in HDPE | 2 Orange | |
| Trials 15-17 | 4% Pigment | 4% Pigment | 4% Pigment | Phthalo Blue | 0 |
| | in HDPE | in HDPE | in HDPE | | |
| Trials 18-20 | 4% Pigment | 4% Pigment | 4% Pigment | Blaze | 0 |
| | in HDPE | in HDPE | in HDPE | Orange/Fire | |
| | | | | Orange | |

TABLE 3
DSC results of several samples evaluated.

| Trial | | | Thickness | | | | | | |
|---|---|---|---|---|---|---|---|---|---|
| Number | Specimen | | (mils) | T_{onset,} ° C. | Tₚₑₐₖ, ° C. | Sᵢ | ΔH_{c}, mJ/mg | % Crystallinity | Δ_{W}, ° C. |
| Trial 1 | [symbol] | HDPE neat | 30 | 100.5 | 92.5 | 5.67 | −65.3 | 77.6 | 17.0 |
| | A | | | | | | | | |
| Trial 9 | [symbol] | HDPE + 4% Y2300F | 30 | 102.9 | 96.3 | 11.43 | −62 | 69.8 | 15.3 |
| | B | | | | | | | | |
| Trial 14 | [symbol] | HDPE + 4% NBPA-2 | 24 | 102.9 | 96.4 | 11.43 | −60.2 | 66.4 | 13.7 |
| | C | | | | | | | | |
| Trial 6 | [symbol] | HDPE + 4% MA50 | 24 | 101.2 | 94 | 11.43 | −59.6 | 64.1 | 13.1 |
| | D | | | | | | | | |
| Trial 17 | [symbol] | HDPE + 4% Phthaloblue | 24 | 102 | 94.3 | 11.43 | −55.5 | 59.2 | 12.4 |
| | E | | | | | | | | |
| Trial 11 | [symbol] | HDPE + 4% Y2300F | 24 | 101.3 | 93.6 | 11.43 | −51.1 | 55.5 | 14.7 |
| | F | | | | | | | | |
| Trial 8 | [symbol] | HDPE + 4% OR2800 | 27 | 101.7 | 94.4 | 11.43 | −44.9 | 47.8 | 12.5 |
| | G | | | | | | | | |
| | [symbol] | | | | | | | | |

HDPE = High Density Polyethylene
Y2300F = 30% Yellow dye comprising a monoazo pigment and a titanate + 70% MA50
NBPA-2 = 50% dye comprising Blaze Orange and Fire Orange + 50% MA50
OR2800 = 20% Orange dye comprising a monoazo pigment and an aminoketone + 80% MA50
MA50 = Milled Attagel 50 palygorskite
Tₒₙₛₑₜ = Starting crystallization temperature
Δ_{W} = Spherulite size distribution
Sᵢ = rate of nucleation (Si = Tan α)
ΔH_{c} = degree of crystallinity
Δ_{fus}h(T)HDPE = Specific heat of fusion depending on temp. of intersection.⁵
% crystallinity = ΔHc/Δfush(T)HDPE

Based on HDPE fracture analysis and DSC, Lucker et al.⁴ demonstrated blow-molded bottles with a high level of crystallinity were more brittle and crack easily under a light impact load. Compositions having hybrid organic/inorganic pigments, such as MayaCrom® Orange OR2800 and MayaCrom® Yellow Y2300F, available from Mayan Pigments, Inc., displayed the lowest crystallinity values when molded at 24 mils wall thickness. Therefore, these materials can increase strength and give color to HDPE in 24 mils wall thickness blow-molded bottles.

Wall Thickness

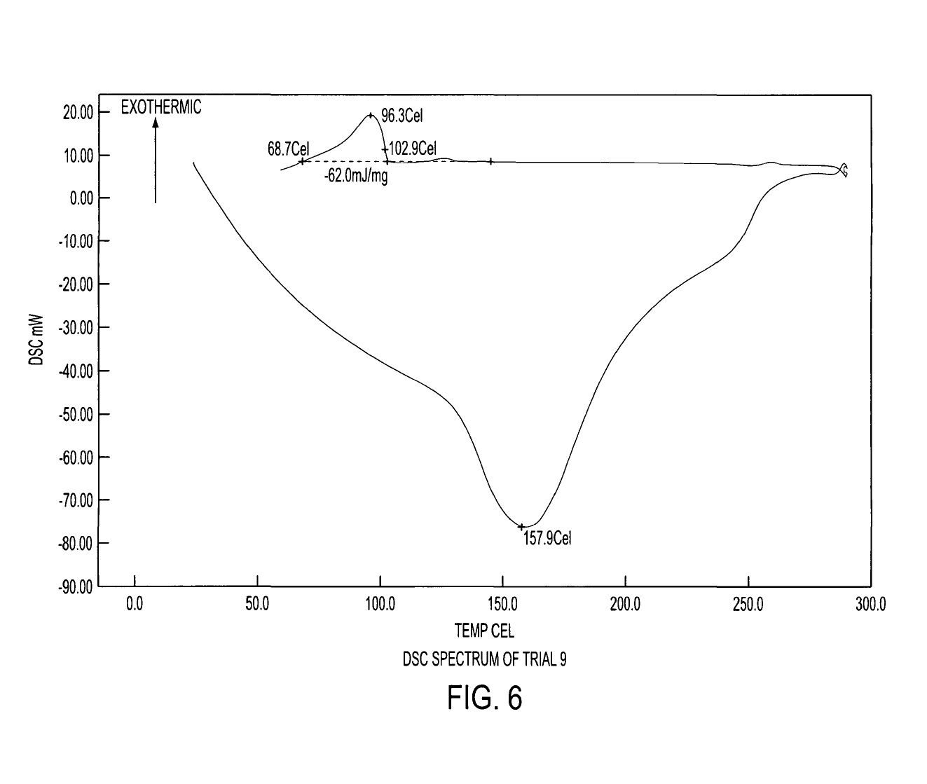

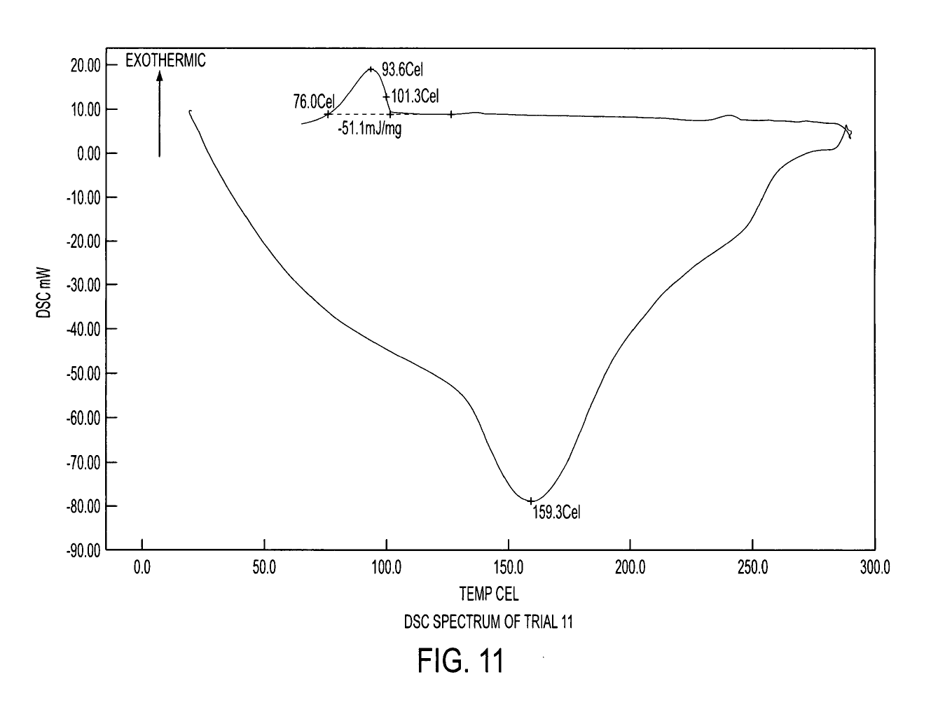

DSC exotherms of samples Trial 9 (FIG. 6) and Trial 11 (FIG. 11) with hybrid organic/inorganic pigment Y2300F and different wall thickness (30 and 24 mils) displayed temperature peak differences of 3.8 (30 mils) and 1.1 (24 mils), respectively. In addition, an increment in crystallization degree was observed to occur from 55.5% (24 mils) to 69.8% (30 mils). These results showed thicker wall thickness increased the % crystallinity and temperature of crystallization, but no major effect in rate of crystallization or spherulite size distribution was observed.

HDPE neat and several HDPE compositions comprising fibrous clay or hybrid organic/inorganic pigment were measured using DSC. In all cases, the addition of fibrous clay or hybrid organic/inorganic pigment played a role as a nucleation agent, increasing rate and reducing spherulite size distribution. Moreover, the degree of crystallinity of these compositions was observed to decrease. Low crystallinity has been reported to improve strength in HDPE containers. Therefore, HDPE with hybrid organic/inorganic pigments Mayacrom™ Y2300F and OR2800 24 mils wall thickness, blow molded containers can improve impact resistance in HDPE blow molded bottles. In certain embodiments of the present disclosure, wall thicknesses as thin as 24 mils or less is desirable in order to maintain the low crystallinity values with the fibrous clay or hybrid organic/inorganic pigments.

Drop tests were performed on blow molded bottles prepared in accordance with the present disclosure. The bottles were filled up with water to within an inch of top and capped. The bottles were then repeatedly dropped from a height of 6 feet until the bottle cracked. As can be seen in Table 4, bottles formed with polymer compositions comprising fibrous clay or hybrid organic/inorganic pigment according to the present disclosure have a greater resistance to failing the drop test than bottles formed from the same polymer but without the fibrous clay or hybrid organic/inorganic pigments. As shown in Table 4, certain embodiments of the present disclosure provide bottles that have about ten times or greater resistance to failure from the drop test than bottles comprising the same polymer but not including the hybrid organic/inorganic pigment. Table 4 further shows that compositions according to the present disclosure, can provide bottle wall thicknesses having thinner walls, while providing greater impact strength, as evidenced by the drop test, than thicker-walled bottles formed from the same polymer without the fibrous clay or hybrid organic/inorganic pigment. In certain embodiments the wall thickness of bottles according to the present disclosure provide significantly improved drop resistance even at about 80% of the wall thickness of bottles without the hybrid organic/inorganic pigment.

TABLE 4
Summary of 6 Foot Drop Tests

| | Pigment | Wall Thickness, | Failure, | Clay in |
|---|---|---|---|---|
| Trial # | Description** | mils | # of Drops | Pigment, % |
| 17 | Phthalo Blue | 24 | 4 | 0 |
| 12 | NBPA-2* | 24 | 41 | 50 |
| 5 | 100% Milled | 27 | 15 | 100 |
| | Clay | | | |
| 10 | Yellow Y2300F | 27 | >50 | 70 |
| 12 | NBPA-2* | 30 | >50 | 50 |
| 15 | Phthalo Blue | 30 | 5 | 0 |
| 7 | Orange OR2800 | 30 | >50 | 80 |

*Hybrid pigment prepared from 50% milled palygorskite clay, 25% Blaze Orange and 25% Fire Orange fluorescent pigments.
**Pigment was 4% by weight in HDPE.

Polymer compositions according to the present disclosure provide thinner wall containers width high impact resistance and faster production lines. Additionally, polymer compositions according to the present disclosure provide an economic benefit, in that they allow thinner walled plastic articles to be provided with improved wall strength, resulting in significant cost savings. In addition, because thinner walled plastic articles can be provided, conservation of fossil-fuel based polymers, such as HDPE can be realized.

The embodiments illustrated in the instant disclosure are for illustrative purposes only. They should not be construed to limit the claims. As is clear to one of ordinary skill in the art, the instant disclosure encompasses a wide variety of embodiments not specifically illustrated herein. While the compositions and methods of this disclosure have been described in terms of exemplary embodiments, it will be apparent to those of skill in the art that variations may be applied to the compositions and methods and in the steps or in the sequence of steps of the method described herein without departing from the concept, spirit and scope of the invention.

### REFERENCES

¹ P. Zou, S. Tang, Z. Fu and H. Xiong, International Journal of Thermal Sciences, 2009, 48, 837-846.
² H. Tavanai, M. Morsched, M. Zarebini, A. S. Rezve, Iranian Polymer Journal, 2005, 14 (3), 267-276
³ E. Harkin-Jones, W. R. Murphy and N. Macauley in Coloring technology for plastics, 1999, p.p. 249-254.
⁴ S. G. Lucker Jr., J. M. Henshaw, C. Dewan, G. M. Eltanany and D. Teeters, Engineering Failure Analysis, 2001, 8, 361-370.
⁵ V. B. F. Mathot and M. F. J. Pijpers, Journal of Thermal Analysis, 1983, 28, 349-358; G. W. H. Hoehne in Differential Scanning calorimetry, Springer, Germany, 2003, 236-237.

What is claimed is:

1. A polymer extrusion or molding composition comprising:
a polymer; and
a fibrous clay and/or a hybrid organic/inorganic pigment, wherein the hybrid organic/inorganic pigment comprises a fibrous clay and an organic dye or organic pigment, and combinations thereof.

2. The polymer extrusion or molding composition according to claim 1, wherein the fibrous clay is palygorskite, sepiolite, or mixtures thereof.

3. The polymer extrusion or molding composition according to claim 2, wherein the extrusion or molding composition comprises the hybrid organic/inorganic pigment and the hybrid organic/inorganic pigment is a reaction product of the organic dye or organic pigment and the clay, and combinations thereof.

4. The polymer extrusion or molding composition according to claim 1, wherein the extrusion or molding composition comprises the hybrid organic/inorganic pigment and the organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof.

5. The polymer extrusion or molding composition according to claim 4, wherein the hybrid organic/inorganic pigment further comprises a rutile pigment, a spinel pigment, a bismuth vanadate pigment, a cerium sulfide pigment, and combinations thereof.

6. The polymer extrusion or molding composition according to claim 1, wherein the polymer is selected from the group consisting of polyolefins, polyesters, polyacrylates, polycarbonates, hydrocarbon resins, polyamides, cellulosics, polyketones, polyethers, polysulfones, polyvinyl alcohols, polyvinyl acetates, polyvinyl butyrals, polyvinyl chlorides, fluoropolymers, polyvinylidene chlorides, polystyrenes, ionomers, silicones, epoxies, phenolics, polyacrylonitriles, polybutadienes, and copolymers and combinations thereof.

7. The polymer extrusion or molding composition according to claim 6, wherein the polymer is a thermoplastic.

8. The polymer extrusion or molding composition according to claim 6, wherein the polymer is a polyolefin selected from the group consisting of ultrahigh molecular weight polyethylene (UHMWPE), high molecular weight polyethylene (HMWPE), high density polyethylene (HDPE), medium density polyethylene (MDPE), low density polyethylene (LDPE), linear low density polyethylene (LLDPE), very low density polyethylene (VLDPE), ultra low molecular weight polyethylene (ULMWPE), isotactic polypropylene, syndiotactic polypropylene, atactic polypropylene, and copolymers and combinations thereof.

9. The polymer extrusion or molding composition according to claim 1, wherein the extrusion or molding composition comprises the hybrid organic/inorganic pigment and the hybrid organic/inorganic pigment comprises from about 1 wt. % to about 90 wt. % clay based on the total weight of the clay and organic dye or organic pigment.

10. The polymer extrusion or molding composition according to claim 1, wherein the extrusion or molding composition comprises from about 0.1 wt. % to about 10 wt. % of the clay or the hybrid organic/inorganic pigment based on the total weight of the polymer extrusion or molding composition.

11. The polymer extrusion or molding composition according to claim 1, wherein the composition is a solid at room temperature.

12. The polymer extrusion or molding composition according to claim 1, wherein the composition further comprises TiO₂.

13. The polymer extrusion or molding composition according to claim 12, wherein the composition comprises TiO₂ particles, and clay particles with an average particle size of about 0.1 to about 100 μm.

14. A plastic component formed from the polymer extrusion or molding composition of claim 1.

15. The plastic component according to claim 14, wherein the component is an extruded component.

16. The plastic component according to claim 14, wherein the component is a film or sheet.

17. The plastic component according to claim 14 wherein the component is an injection molded component.

18. The plastic component according to claim 14, wherein the component is a blow molded component.

19. The plastic component according to claim 18, wherein the component is a bottle.

20. An extruded plastic film comprising a polymer composition, the polymer composition comprising:
a polymer; and
a fibrous clay and/or a hybrid organic/inorganic pigment, wherein the hybrid organic/inorganic pigment comprises a fibrous clay and an organic dye or organic pigment, and combinations thereof.

21. The extruded plastic film according to claim 20, wherein the clay is palygorskite, sepiolite, or mixtures thereof.

22. The extruded plastic film according to claim 20, wherein the film comprises the hybrid organic/inorganic pigment and the hybrid organic/inorganic pigment is a reaction product of the organic dye or organic pigment and the clay, and combinations thereof.

23. The extruded plastic film according to claim 20, wherein the film comprises the hybrid organic/inorganic pigment and the organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof.

24. The extruded plastic film according to claim 23, wherein the hybrid organic/inorganic pigment further comprises a rutile pigment, a spinel pigment, a bismuth vanadate pigment, a cerium sulfide pigment, and combinations thereof.

25. The extruded plastic film according to claim 20, wherein the film further comprises TiO₂.

26. The extruded plastic film according to claim 25, wherein the film comprises wherein the composition comprises TiO₂ particles, and clay particles with an average particle size of about 0.1 to about 100 μm.

27. The extruded plastic film according to claim 20, wherein the polymer is selected from the group consisting of polyolefins, polyesters, polyamides, cellulosics, polyvinyl acetates, fluoropolymers, polyvinylidene chlorides, polyvinyl chlorides, polycarbonates, and copolymers and combinations thereof.

28. The extruded plastic film according to claim 27, wherein the polymer is a polyolefin selected from the group consisting of high density polyethylene (HDPE), medium density polyethylene (MDPE), low density polyethylene (LDPE), linear low density polyethylene (LLDPE), polypropylene, and copolymers and combinations thereof.

29. The extruded plastic film according to claim 20, wherein the film comprises the hybrid organic/inorganic pigment and the hybrid organic/inorganic pigment comprises from about 1 wt. % to about 90 wt. % clay based on the total weight of the clay and organic dye or organic pigment.

30. The extruded plastic film according to claim 20, wherein the film comprises from about 0.1 wt. % to about 10 wt. % of clay and/or hybrid organic/inorganic pigment based on the total weight of the plastic film.

31. A molded plastic container comprising:
a polymer; and
a fibrous clay and/or a hybrid organic/inorganic pigment, wherein the hybrid organic/inorganic pigment comprises a fibrous clay and an organic dye or organic pigment, and combinations thereof.

32. The molded plastic container according to claim 31, wherein the clay is palygorskite, sepiolite, or mixtures thereof.

33. The molded plastic container according to claim 31, wherein the container comprises the hybrid organic/inorganic pigment and the hybrid organic/inorganic pigment is a reaction product of the organic dye or organic pigment and the clay, and combinations thereof.

34. The molded plastic container according to claim 31, wherein the container comprises the hybrid organic/inorganic pigment and the hybrid organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof.

35. The molded plastic container according to claim 34, wherein the hybrid organic/inorganic pigment further comprises a rutile pigment, a spinel pigment, a bismuth vanadate pigment, a cerium sulfide pigment, and combinations thereof.

36. The molded plastic container according to claim 34, wherein the polymer is selected from the group consisting of polyolefins, polyesters, polycarbonates, polyamides, polyvinyl chlorides, polyacrylonitriles, polybutadienes, polystyrenes, and copolymers and combinations thereof.

37. The molded plastic container according to claim 36, wherein the polymer is selected from the group consisting of high density polyethylene (HDPE), medium density polyethylene (MDPE), low density polyethylene (LDPE), linear low density polyethylene (LLDPE), polypropylene, polyethylene terephthalate, polybutylene terephthalate, polyhexamethylene adipamide, polycarbonate, acrylonitrile-butadiene-styrene (ABS) copolymer, and copolymers and combinations thereof.

38. The molded plastic container according to claim 37, wherein the molded container is a blow molded or injection molded bottle.

39. The molded plastic container according to claim 31, wherein the container further comprises TiO₂.

40. The molded plastic container according to claim 39, wherein the container comprises TiO₂ particles, and clay particles with an average particle size of about 0.1 to about 100 μm.

41. The molded plastic container according to claim 31, wherein the container comprises the hybrid organic/inorganic pigment and the hybrid organic/inorganic pigment comprises from about 1 wt. % to about 90 wt. % clay based on the total weight of the clay and organic dye or organic pigment.

42. The molded plastic container according to claim 31, wherein the container comprises from about 0.1 wt. % to about 10 wt. % fibrous clay and/or hybrid organic/inorganic pigment based on the total weight of the molded container.

43. The molded plastic container according to claim 33, wherein the molded container has improved mechanical and physical properties and greater resistance to failure from dropping six feet onto a hard surface than molded containers comprising a same polymer but not including the fibrous clay or hybrid organic/inorganic pigment.

44. The molded plastic container according to claim 43, wherein the container has about ten times or greater resistance to failure from dropping six feet onto a hard surface than molded containers comprising a same polymer, but not including the fibrous clay or hybrid organic/inorganic pigment.

45. The molded container according to claim 44, wherein the container has a wall thickness of about 80% the wall thickness of said molded containers not including the fibrous clay or hybrid organic/inorganic pigment.

46. A method of making a plastic component comprising:
forming a polymer composition by mixing a polymer and a fibrous clay and/or a hybrid organic/inorganic pigment, wherein the hybrid organic/inorganic pigment comprises a fibrous clay and an organic dye or organic pigment, and combinations thereof;
melting the polymer composition; and
molding or extruding the melted polymer composition.

47. The method of making a plastic component according to claim 46, wherein the clay is palygorskite, sepiolite, or mixtures thereof.

48. The method of making a plastic component according to claim 46, wherein the polymer composition comprises the hybrid organic/inorganic pigment and the hybrid organic/inorganic pigment is a reaction product of the organic dye or organic pigment and the clay, and combinations thereof.

49. The method of making a plastic component according to claim 46, wherein the polymer composition comprises the hybrid organic/inorganic pigment and the organic dye or organic pigment is selected from the group consisting of indigo, molecular derivatives of indigo, thioindigos, molecular derivatives of thioindigo, anthraquinones, anthrathrones, anthrapyrimidines, monoazos, diazos, azomethines, quinacridones, quinophthalones, diketopyrrolopyrrols, inanthrones, isoindolines, perylenes, perinones, phthalocyanines, pyranthrones, pyrazolo-quinazolones, diphenylmethanes, acridines, xanthenes, triarylmethanes, thiazines, indophenols, indulines, nigrosines, aminoazobenzenes, anilines, benzimidazoles, benzopyrans, quinolines, aminoketones, alizarins, naphthalimides, acridones, anthracenediones, anthrathioxanthenones, carmine, beta carotene, carmine hydrosoluble, turmeric, beet, annato, metal complex dyes, metal complex pigments, azo/metal complexes, and combinations thereof.

50. The method of making a plastic component according to claim 49, wherein the hybrid organic/inorganic pigment further comprises a rutile pigment, a spinel pigment, a bismuth vanadate pigment, a cerium sulfide pigment, and combinations thereof.

51. The method of making a plastic component according to claim 46, wherein the polymer is selected from the group consisting of polyolefins, polyesters, polyacrylates, polycarbonates, hydrocarbon resins, polyamides, cellulosics, polyketones, polyethers, polysulfones, polyvinyl alcohols, polyvinyl acetates, polyvinyl butyrals, polyvinyl chlorides, fluoropolymers, polyvinylidene chlorides, polyacrylonitriles, polybutadienes, polystyrenes, ionomers, silicones, epoxies, phenolics, and copolymers and combinations thereof.

52. The method of making a plastic component according to claim 51, wherein the polymer is a thermoplastic.

53. The method of making a plastic component according to claim 46, wherein the melted polymer composition is extruded by blown film extrusion or cast film extrusion.

54. The method of making a plastic component according to claim 46, wherein the melted polymer composition is molded by blow molding or injection molding.
